(19) United States
(12) Patent Application Publication
(10) Pub. No.: US 2017/0230881 A1
(43) Pub. Date: Aug. 10, 2017

(54) Method and Apparatus for Setting Reselection Priority and Determining and Processing Reselection Catergory

(71) Applicant: ZTE Corporation, Shenzhen (CN)

(72) Inventor: Yuanfang YU, Shenzhen (CN)

(73) Assignee: ZTE CORPORATION, Shenzhen (CN)

(21) Appl. No.: 15/502,580

(22) PCT Filed: Mar. 20, 2015
(86) PCT No.: PCT/CN2015/074797

§ 371 Date: Feb. 8, 2017

(30) Foreign Application Priority Data
Sep. 29, 2014 (CN) 201410515781.8

(51) Int. Cl. H04W 36/26; H04W 36/00

(52) U.S. Cl. CPC H04W 36/26; H04W 36/0072; H04W 36/0094

(57) ABSTRACT

A method and device for setting a reselection priority, a method and device for determining a reselection category and a method and device for processing a reselection category are disclosed. In the method, a first notification message is received from a network-side device, moreover the first notification message carries information of multiple carriers or cells supporting stochastic uniform distribution; and one carrier or cell is selected from the multiple carriers or cells according to the first notification message, and the reselection priority of the selected carrier or cell is set.

### TECHNICAL FIELD

The disclosure relates to the field of communications, and in particular to a method and device for setting a reselection priority, a method and device for determining a reselection category and a method and device for processing a reselection category.

### BACKGROUND

A Long Term Evolution (LTE) is a technical standard developed by a 3rd Generation Partnership Project (3GPP) for a Universal Mobile Telecommunications system (UMTS). As the LTE is being deployed widely, a balanced distribution of idle terminals faces a new challenge.

With the LTE being deployed in a large scale, it is predicable that there will be more and more LTE terminals and LTE services. Terminals in a connected state can be distributed into different carriers or into different cells through load information interaction, dual-link, carrier aggregation, switching or redirecting so as to balance a load caused by the terminals. However, FIG. 1 is a schematic diagram illustrating an idle reselection mechanism. As shown in FIG. 1, existing idle cell reselection mechanisms (public frequency priority) may cause all idle terminals to converge on a carrier of the highest priority, making it highly possible to violate a balancing strategy for loads in a connected state and potentially causing an overload problem.

Different types of cells may coexist in a LTE network to constitute a heterogeneous network, and the heterogeneous network will be a typical network for an LTE deployment. In a scenario in which a multiple types of cells coexist, because a load of a small cell is diverse and a coverage range of the small cell is relatively small, blindly guiding a terminal into the small cell may disenable an access of the terminal or lead to an increase in a power consumption of the terminal, resulting in a degradation in user experience. On the other hand, utilizing a small cell to the greatest degree possible is also an original intention of operators in deploying the small cell. However, FIG. 2 is a schematic diagram illustrating an idle mechanism. As shown in FIG. 2, it is different for existing idle cell reselection mechanisms (public frequency priority) to control a residence of an idle terminal in a small cell, for example, once a frequency priority of a small cell is improved, all the terminals in the coverage range of the small cell will reselect to reside in the small cell, which may potentially cause an access problem and degrading experience on a subsequently connected service.

In conclusion, an idle cell reselection mechanism always causes terminals to converge on a high-priority frequency, leading to difficulty in access and poor user experience.

### SUMMARY

A method and device for setting a reselection priority, a method and device for determining a reselection category and a method and device for processing a reselection category are provided herein so as at least to solve a problem that an idle cell reselection mechanism always causes terminals to converge on a high-priority frequency and consequentially brings difficulty to access and poor user experience.

In an embodiment of the disclosure, a method for setting a reselection priority is provided.

The method for setting the reselection priority provided in this embodiment of the disclosure includes: receiving a first notification message from a network-side device, wherein the first notification message carries information of multiple carriers or cells supporting stochastic uniform distribution; and selecting one carrier or cell from the multiple carriers or cells according to the first notification message and setting the reselection priority of the selected carrier or cell.

In an example embodiment, setting the reselection priority of the selected carrier or cell includes: setting the reselection priority of the selected carrier or cell to be the highest in reselection priorities of the multiple carriers or cells.

In an example embodiment, after setting the reselection priority of the selected carrier or cell, the method further includes: setting a reselection priority of a currently resident carrier or cell to be lowest in the reselection priorities of the multiple carriers or cells.

In an example embodiment, after setting the reselection priority of the selected carrier or cell, the method further includes: executing a cell reselection operation according to the set reselection priority.

In an example embodiment, after executing a cell reselection operation according to the set reselection priority, the method further includes: setting a timer or acquiring a timer from the network-side device, wherein the set reselection priority is continually used and a reselection priority of a carrier or cell received from a system message is ignored in a time range limited by the timer.

In an example embodiment, after setting the reselection priority of the selected carrier or cell, the method further includes: receiving a second notification message from the network-side device, wherein the second notification message is used for notifying to delete the multiple carriers or cells or to set corresponding reselection activation indication fields of multiple carriers or cells to be deactivated; and deleting or deactivating the multiple carriers or cells according to the second notification message.

In another embodiment of the disclosure, a method for determining a reselection category is provided.

The method for determining the reselection category provided in this embodiment of the disclosure includes: determining the reselection category a terminal belongs to; and notifying the terminal of the reselection category.

In an example embodiment, determining the reselection category the terminal belongs to includes one of the following steps: determining the reselection category through a negotiation with the terminal; allocating the reselection category for the terminal; and determining the reselection category based on an algorithm supported by the terminal and locally supported.

In an example embodiment, reference factors of the reselection category include one of: subscription information of the terminal and capability information of the terminal.

In another embodiment of the disclosure, a method for processing a reselection category is provided.

The method for processing the reselection category provided in this embodiment of the disclosure includes: determining a reselection category list, wherein the reselection category list includes at least one of: a reselection category of a terminal which keeps residing in a current cell, and a reselection category of a terminal which is to reselect to reside on another carrier; and notifying a terminal of the reselection category list.

In an example embodiment, while or after notifying the terminal of the reselection category list, the method further includes: notifying the terminal of multiple carriers or cells supporting stochastic uniform distribution.

In an example embodiment, the terminal compares a reselection category of the terminal with the received reselection category list to determine that the reselection category of the terminal belongs to a reselection category, which is to reselect onto another carrier, determines a reselection priority of the terminal and perfroms a cell reselection operation according to a list of multiple carriers or cells supporting stochastic uniform distribution received by the terminal.

In another embodiment of the disclosure, a device for setting a reselection priority is provided.

The device for setting the reselection priority provided in this embodiment of the disclosure includes: a first receiving component arranged to receive a first notification message from a network-side device, wherein the first notification message carries information of multiple carriers or cells supporting stochastic uniform distribution; and a setting component arranged to select one carrier or cell from the multiple carriers or cells according to the first notification message and set the reselection priority of the selected carrier or cell.

In an example embodiment, the setting component is arranged to set the reselection priority of the selected carrier or cell to be the highest in reselection priorities of the multiple carriers or cells.

In an example embodiment, the setting component is also arranged to set a reselection priority of a currently resident carrier or cell to be lowest in the reselection priorities of the multiple carriers or cells.

In an example embodiment, the device further includes: an execution component arranged to execute a cell reselection operation according to the set reselection priority.

In an example embodiment, the device further includes: a first processing component arranged to set a timer or acquire a timer from the network-side device, wherein the set reselection priority is continually used and a reselection priority of a carrier or cell received from a system message is ignored in a time range limited by the timer.

In an example embodiment, the device further includes: a second receiving component arranged to receive a second notification message from the network-side device, wherein the second notification message is used for notifying to delete the multiple carriers or cells or to set corresponding reselection activation indication fields of multiple carriers or cells to be deactivated; and a second processing component arranged to delete or deactivate the multiple carriers or cells according to the second notification message.

In another embodiment of the disclosure, a device for determining a reselection category is provided.

The device for determining the reselection category provided in this embodiment of the disclosure includes: a determination component arranged to determine the reselection category a terminal belongs to; and a notification component arranged to notify the terminal of the reselection category.

In an example embodiment, the determination component is arranged to determine the reselection category a terminal belongs to in one of the following ways: determine the reselection category through a negotiation with the terminal; allocate the reselection category for the terminal; and determine the reselection category based on an algorithm supported by the terminal and the device for determining the reselection category.

In an example embodiment, reference factors of the reselection category include one of: subscription information of the terminal and capability information of the terminal.

In another embodiment of the disclosure, a device for processing a reselection category is provided.

The device for processing the reselection category provided in this embodiment of the disclosure includes: a determination component arranged to determine a reselection category list, wherein the reselection category list includes at least one of: a reselection category of a terminal which keeps residing in a current cell, and a reselection category of a terminal which is to reselect to reside on another carrier; and a notification component arranged to notify a terminal of the reselection category list.

In an example embodiment, the notification component is further arranged to notify the terminal of multiple carriers or cells supporting stochastic uniform distribution.

By receiving a first notification message from a network-side device, wherein the first notification message carries the information of a multiple carriers or cells supporting stochastic uniform distribution; selecting one carrier or cell from the multiple carriers or cells according to the first notification message and setting the reselection priority of the selected carrier or cell, the embodiments of the disclosure solve the problem that the idle cell reselection mechanism always causes terminals to converge on a high-priority frequency and consequentially brings difficulty to access and poor user experience and therefore realize the uniform distribution of idle terminals on the multiple carriers.

### BRIEF DESCRIPTION OF DRAWINGS

The accompanying drawings described herein which are incorporated into and form a part of the application are provided for the better understanding of the disclosure, and exemplary embodiments of the disclosure and the description of the exemplary embodiments serve to illustrate the disclosure but are not to be construed as improper limitations to the disclosure. In the accompanying drawings:

FIG. 1 is a schematic diagram illustrating an idle reselection;

FIG. 2 is a schematic diagram illustrating an idle mechanism;

FIG. 3 is a flowchart illustrating a method for setting a reselection priority according to an embodiment of the disclosure;

FIG. 4 is a flowchart illustrating a method for determining a reselection category according to an embodiment of the disclosure;

FIG. 5 is a flowchart illustrating a method for processing a reselection category according to an embodiment of the disclosure;

FIG. 6 is a flowchart illustrating a flow of a stochastic uniform distribution reselection according to an example embodiment of the disclosure;

FIG. 7 is a flowchart illustrating a flow of a Hash reselection based on reselection categories of terminals according to an example embodiment of the disclosure;

FIG. 8 is a structural block diagram illustrating a device for setting a reselection priority according to an embodiment of the disclosure;

FIG. 9 is a structural block diagram illustrating a device for setting a reselection priority according to an example embodiment of the disclosure;

FIG. 10 is a structural block diagram illustrating a device for determining a reselection category according to an embodiment of the disclosure; and

FIG. 11 is a structural block diagram illustrating a device for processing a reselection category according to an embodiment of the disclosure.

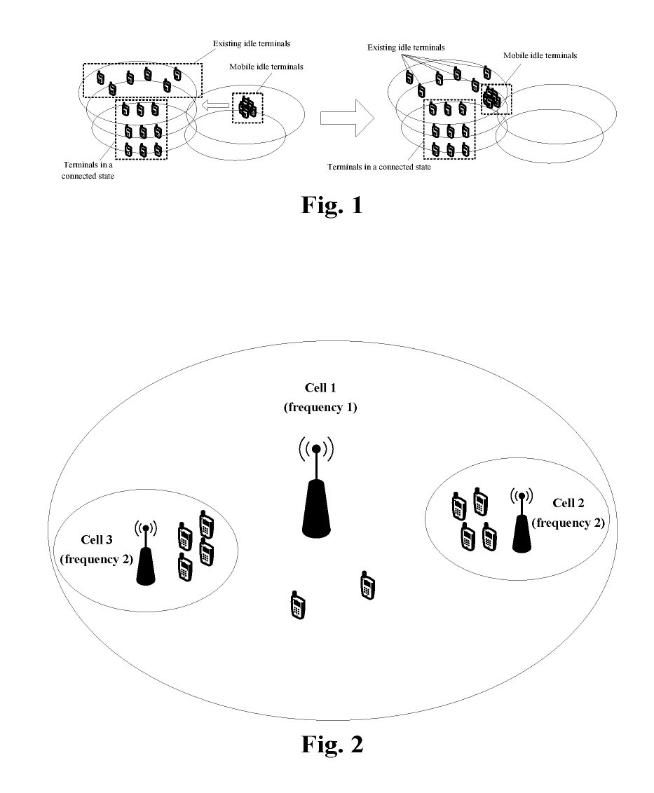

### DETAILED DESCRIPTION OF THE EMBODIMENTS

The disclosure will be described below in detail with reference to accompanying drawings when read in conjunction with specific embodiments. It should be noted that the embodiments of the disclosure and the features thereof can be combined with each other if no conflict is caused.

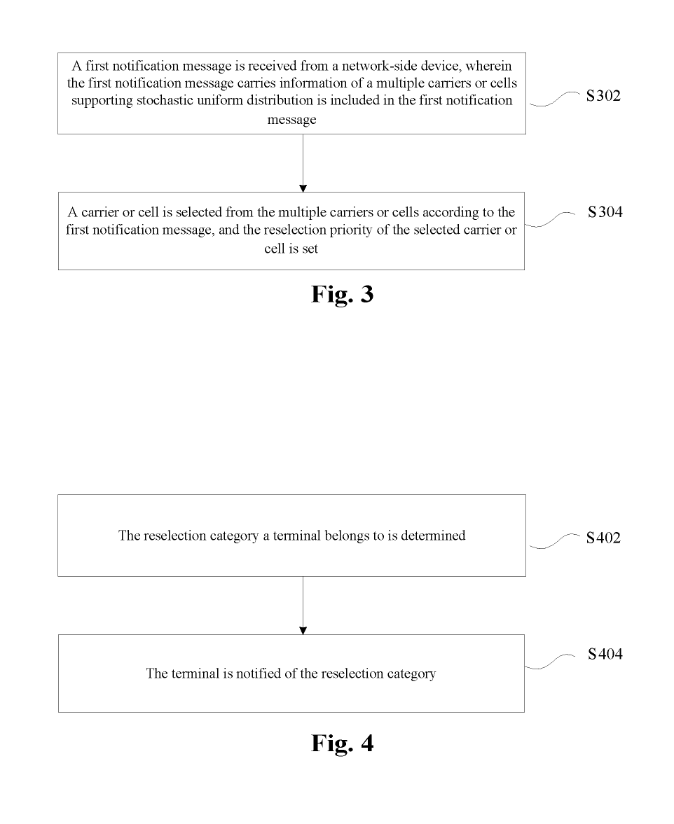

FIG. 3 is a flowchart illustrating a method for setting a reselection priority according to an embodiment of the disclosure. As shown in FIG. 3, the method may include the following Steps:

S302: a first notification message is received from a network-side device, moreover the first notification message carries information of a multiple carriers or cells supporting stochastic uniform distribution is included in the first notification message; and

S304: a carrier or cell is selected from the multiple carriers or cells according to the first notification message, and the reselection priority of the selected carrier or cell is set.

An idle cell reselection mechanism always causes terminals to converge on a high-priority frequency and consequentially brings difficulty to access and poor user experience. By using the method shown in FIG. 3, the network-side device can provide the terminal with the information of a multiple carriers or cells supporting stochastic uniform distribution (e.g. a carrier or cell list) and indicate that the multiple carriers or cells can be reselected using a stochastic uniform distribution algorithm (e.g. the Hash algorithm). Each carrier or cell is set with a corresponding indicator for activating a reselection based on the stochastic uniform distribution algorithm so that the terminal can select, from the multiple carriers or cells, a carrier or cell to reside in instead of converging on the high-priority frequency. In this way, the problem that the idle cell reselection mechanism always causes terminals to converge on the high-priority frequency and consequentially brings difficulty to access and poor user experience is solved, thereby realizing a uniform distribution of idle terminals on multiple carriers.

In an example embodiment, in S304, setting the reselection priority of the selected carrier or cell may include the following Steps:

Step S1: the reselection priority of the selected carrier or cell is set to be the highest in reselection priorities of the multiple carriers or cells.

When a network side desires to activate a method for a cell reselection based on the stochastic uniform distribution algorithm (e.g. the Hash algorithm), the network side provides a carrier or cell list for the terminal and indicates that the multiple carriers or cells included in the carrier or cell list can be reselected using the stochastic uniform distribution algorithm (e.g. the Hash algorithm). The terminal can select, according to the stochastic uniform distribution algorithm (e.g. the Hash algorithm), one carrier or cell from the carrier or cell list in which carriers or cells supporting the reselection function are listed and set the reselection priority of the selected carrier or cell to be highest.

In an example embodiment, after setting the reselection priority of the selected carrier or cell, S304 may further include the following Step:

Step S2, a reselection priority of a currently resident carrier or cell is set to be lowest in the reselection priorities of the multiple carriers or cells.

Generally, a continuous residence of the terminal in the currently resident cell or carrier is not desired, thus, the reselection priority of the currently resident cell or carrier is set to be lowest.

In an example embodiment, after setting the reselection priority of the selected carrier or cell, S304 may further include the following Step:

Step S3: a cell reselection operation is executed according to the set reselection priority.

Once the terminal selects, according to the stochastic uniform distribution algorithm, one carrier or cell from the carrier or cell list in which carriers or cells supporting the reselection function are listed and sets, according to the stochastic uniform distribution algorithm, the reselection priority of the selected carrier or cell to be highest, the cell reselection operation can be executed according to the set reselection priority.

In an example embodiment, after executing a cell reselection operation according to the set reselection priority, S3 may further include the following Step:

Step S4: a timer is set or acquired from the network-side device, moreover the set reselection priority is continually used and a reselection priority of a carrier or cell received from a system message is ignored in a time range limited by the timer.

The timer can be provided by the network-side device or set by the terminal. Before the time set by the timer is up, the terminal continues to use the set cell reselection priority set through a reselection based on the stochastic uniform distribution algorithm and ignores the cell reselection priority of a frequency or cell received from the system message.

In an example embodiment, after setting the reselection priority of the selected carrier or cell, S304 may further include the following Steps:

Step S5: a second notification message is received from the network-side device, moreover the second notification message is used for notifying to delete the multiple carriers or cells or to set corresponding reselection activation indication fields of multiple carriers or cells to be deactivated; and

Step S6: the multiple carriers or cells are deleted or deactivated according to the second notification message.

In an example embodiment, when a network side device desires to deactivate the method for the cell reselection based on the stochastic uniform distribution algorithm (e.g. the Hash algorithm), the network side updates a notification message sent to the terminal and deletes the carrier or cell list in which carriers or cells based on the stochastic uniform distribution algorithm (e.g. the Hash algorithm) are included or sets corresponding reselection activation indicators in the carrier list to be deactivated. The terminal may delete the carrier or cell list according to a message sent by the network side or deactivate the reselection function based on the stochastic uniform distribution algorithm.

FIG. 4 is a flowchart illustrating a method for determining a reselection category according to an embodiment of the disclosure. As shown in FIG. 4, the method for determining the reselection category may include the following Steps:

Step S402: the reselection category a terminal belongs to is determined; and

Step S404: the terminal is notified of the reselection category.

In an example embodiment, a network-side device may broadcast reselection category information which may include at least one of: the reselection category of the terminal which can keep residing in a current cell and the reselection category of the terminal reselecting to reside on another carrier, moreover, the network-side device can broadcast, based on a capability of the network-side device, a reselection category of a terminal having priority to residing in a coverage area of the network-side device.

In an example implementation process, the reselection category a terminal belongs to is determined in one of the following ways:

Way 1: determining the reselection category through a negotiation with the terminal;

Way 2: allocating the reselection category for the terminal; and

Way 3: determining the reselection category based on an algorithm supported by the terminal and locally supported.

In an example embodiment, reference factors of the reselection category include one of: subscription information of the terminal and capability information of the terminal.

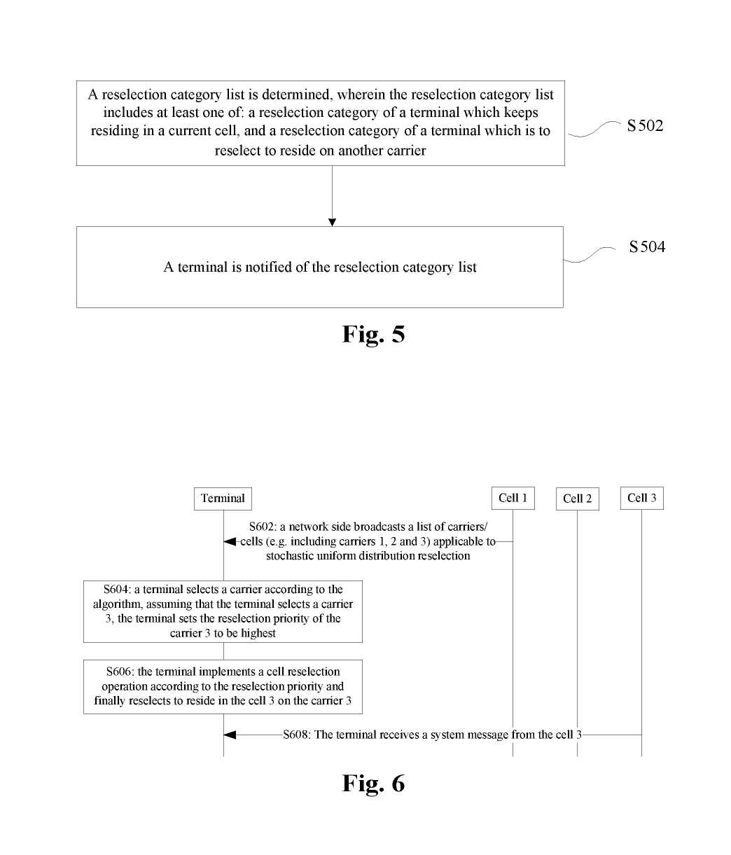

FIG. 5 is a flowchart illustrating a method for processing a reselection category according to an embodiment of the disclosure. As shown in FIG. 5, the method may include the following processing Steps:

Step S502: a reselection category list is determined, moreover the reselection category list includes at least one of: a reselection category of a terminal which keeps residing in a current cell, and a reselection category of a terminal which is to reselect to reside on another carrier; and

Step S504: a terminal is notified of the reselection category list.

In an example embodiment, while or after Step S504 the terminal is notified of the reselection category list, the method may further include the following Step:

Step S7: the terminal is notified of multiple carriers or cells supporting stochastic uniform distribution so that the terminal can select a carrier or cell from the multiple carriers or cells to set the priority of the selected carrier or cell to be highest and implement a cell reselection operation.

In an example implementation process, the terminal compares a reselection category of the terminal with the received reselection category list to determine that the reselection category of the terminal belongs to a reselection category, which is to reselect onto another carrier, determines a reselection priority of the terminal and performs a cell reselection operation according to a list of multiple carriers or cells supporting stochastic uniform distribution received by the terminal.

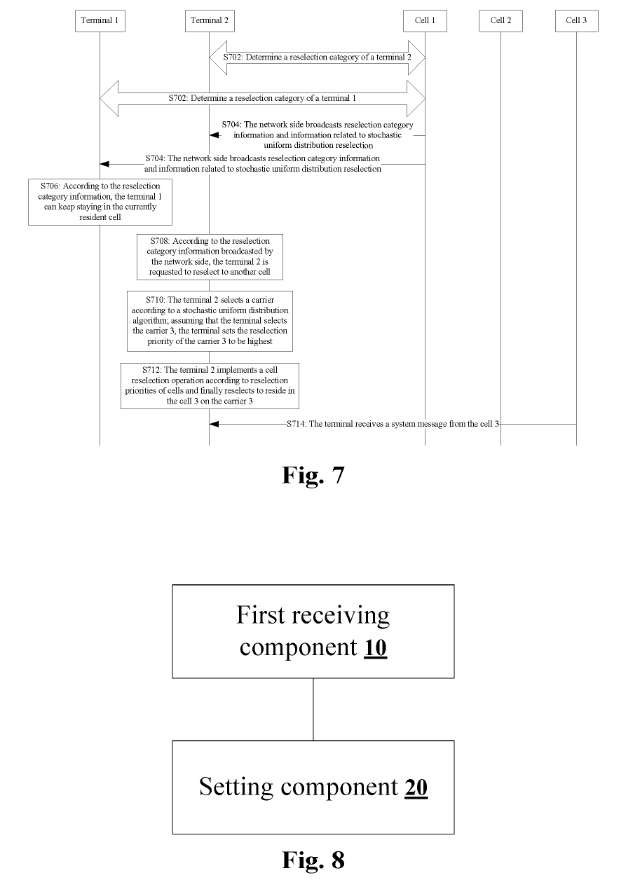

The foregoing example implementation processes will be described further below with reference to the example implementation modes shown in FIG. 6 and FIG. 7.

FIG. 6 is a flowchart illustrating a flow of a stochastic uniform distribution reselection according to an example embodiment of the disclosure. As shown in FIG. 6, the flow may include the following processing Steps:

Step S602: a network side broadcasts a list of carriers/cells applicable to stochastic uniform distribution reselection, optionally; the network side may also broadcast a duration of a stochastic uniform distribution reselection retention timer.

Step S604: a terminal selects a carrier according to a stochastic uniform distribution reselection algorithm (e.g. the Hash algorithm) supported by the terminal. In the stochastic uniform distribution reselection algorithm, the list of carriers/cells broadcasted by the network side and supportive to a reselection based on the stochastic uniform distribution algorithm is used as input parameters, and the carrier/cell to be selected by the terminal is used as output parameters. It is assumed that the terminal selects a carrier 3, the terminal sets a reselection priority of the carrier 3 to be highest.

Step S606: the terminal executes a cell reselection operation according to a reselection priority of a cell and finally reselects to reside in a cell 3 on the carrier 3, and the terminal sets a stochastic uniform distribution reselection retention timer.

Step S608: the terminal receives a system message from the cell 3; however, before the time set by the stochastic uniform distribution reselection retention timer is up, the terminal continues to use the cell reselection priority set through a reselection based on the stochastic uniform distribution algorithm and ignores a cell reselection priority of a frequency or cell received from the system message.

FIG. 7 is a flowchart illustrating a flow of a Hash reselection based on reselection categories of terminals according to an example embodiment of the disclosure. As shown in FIG. 7, the flow may include the following processing Steps:

Step S702: the reselection categories of a terminal 1 and a terminal 2 are determined, moreover a network side determines reselection categories of the terminals belong to by negotiating with the terminals, or the network side allocates reselection categories for the terminals, or the network side determines the reselection categories of the terminals belong to based on an algorithm comprehensible to both the network side and the terminals, and the reselection categories can be determined by taking subscription information of the terminals and capabilities of the terminals into overall consideration.

Step S704: the network side broadcasts reselection category information and a list of carriers/cells applicable to stochastic uniform distribution reselection, optionally; the network side may also broadcast a duration of a stochastic uniform distribution reselection retention timer, moreover the network side may broadcast, based on the capability of the network side, a reselection category of a terminal having priority to residing in the coverage area of the network-side device.

Step S706: according to the reselection category information broadcasted by the network side, terminals belonging to the reselection category of the terminal 1 can keep staying in a currently resident cell.

Step S708: according to the reselection category information broadcasted by the network side, terminals belonging to the reselection category of the terminal 2 cannot stay in the currently resident cell any longer;

Step S710: the terminal 2 selects a carrier according to a stochastic uniform distribution algorithm. It is assumed that the terminal 2 selects a carrier 3, the terminal 2 sets the reselection priority of the carrier 3 to be highest;

Step S712: the terminal 2 executes a cell reselection operation according to the reselection priority of the cell and finally reselects to reside in the cell 3 on the carrier 3; the terminal 2 sets the stochastic uniform distribution reselection retention timer, and when a duration of the timer is broadcasted by the network side, the terminal 2 sets the duration of the timer according to the parameters broadcasted by the network side, otherwise, the terminal sets the duration of the timer to be a defaulted value; and

Step S714: the terminal 2 receives a system message from the cell 3; however, before the time set by the stochastic uniform distribution reselection retention timer is up, the terminal continues to use the cell reselection priority set through a reselection based on the stochastic uniform distribution algorithm and ignores the cell reselection priority of a frequency or cell received from the system message.

FIG. 8 is a structural block diagram illustrating a device for setting a reselection priority according to an embodiment of the disclosure. As shown in FIG. 8, the device for setting the reselection priority includes: a first receiving component 10 arranged to receive a first notification message from a network-side device, moreover the first notification message carries information of multiple carriers or cells supporting stochastic uniform distribution; and a setting component 20 arranged to select one carrier or cell from the multiple carriers or cells according to the first notification message and set the reselection priority of the selected carrier or cell.

The device shown in FIG. 8 solves the problem that the idle cell reselection mechanism always causes terminals to converge on a high-priority frequency and consequentially brings difficulty to access and poor user experience and realizes the uniform distribution of idle terminals on multiple carriers.

In an example embodiment, the setting component 20 is arranged to set the reselection priority of the selected carrier or cell to be the highest in reselection priorities of the multiple carriers or cells.

In an example embodiment, the setting component 20 is also arranged to set a reselection priority of a currently resident carrier or cell to be lowest in the reselection priorities of the multiple carriers or cells.

In an example embodiment, as shown in FIG. 9, the device further includes: an execution component 30 arranged to execute a cell reselection operation according to the set reselection priority.

In an example embodiment, as shown in FIG. 9, the device further includes: a first processing component 40 arranged to set a timer or acquire a timer from the network-side device, moreover the set reselection priority is continually used and a reselection priority of a carrier or cell received from a system message is ignored in a time range limited by the timer.

In an example embodiment, as shown in FIG. 9, the device further includes: a second receiving component 50 arranged to receive a second notification message from the network-side device, moreover the second notification message is used for notifying to delete the multiple carriers or cells or to set corresponding reselection activation indication fields of multiple carriers or cells to be deactivated; and a second processing component 60 arranged to delete or deactivate the multiple carriers or cells according to the second notification message.

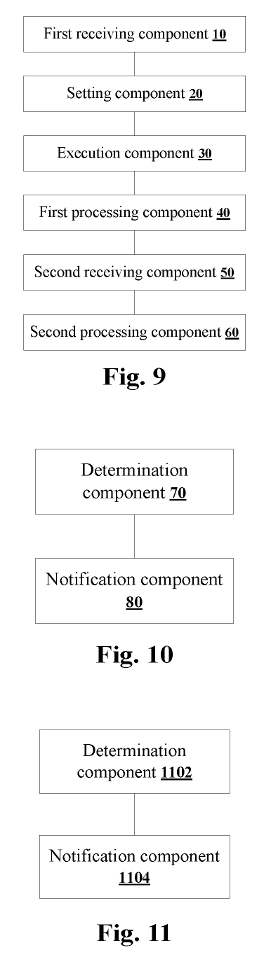

FIG. 10 is a structural block diagram illustrating a device for determining a reselection category according to an embodiment of the disclosure. As shown in FIG. 10, the device for determining the reselection category determination includes: a determination component 70 arranged to determine the reselection category a terminal belongs to, and a notification component 80 arranged to notify the terminal of the reselection category.

In an example embodiment, the determination component 70 is arranged to determine the reselection category a terminal belongs to in one of the following ways:

Way 1: determine the reselection category through a negotiation with the terminal;

Way 2: allocate the reselection category for the terminal; and

Way 3: determine the reselection category based on an algorithm supported by the device for determining the reselection category and the terminal.

In an example implementation process, reference factors of the reselection category include one of: the subscription information of the terminal and the capability information of the terminal.

FIG. 11 is a structural block diagram illustrating a device for processing a reselection category according to an embodiment of the disclosure. As shown in FIG. 11, the device for processing the reselection category includes: a determination component 1102 arranged to determine a reselection category list, moreover the reselection category list includes at least one of: a reselection category of a terminal which keeps residing in a current cell, and a reselection category of a terminal which is to reselect to reside on another carrier; and a notification component 1104 arranged to notify a terminal of the reselection category list.

In an example embodiment, the notification component 1104 is further arranged to notify the terminal of multiple carriers or cells supporting stochastic uniform distribution.

It can be seen from the foregoing description that the foregoing embodiments realize the following technical effect (it should be noted that the effects are achievable to some example embodiments): by adopting the technical solutions provided herein, the cell reselection method based on the stochastic uniform distribution algorithm (e.g. the Hash algorithm) and the cell reselection method based on the combination of reselection categories of terminals and the stochastic uniform distribution algorithm (e.g. the Hash algorithm) realize the uniform distribution of idle terminals on multiple carriers.

Apparently, it should be appreciated by those skilled in the art that each component or step described in the disclosure can be realized by a universal computer and that the components or steps may be integrated on a single computer or distributed on a network consisting of a multiple computers, optionally, the components or steps may be realized by executable program codes so that the components or steps can be stored in a memory to be executed by a computer, and in some cases, the steps shown or described herein can be executed in a sequence different from this presented herein, or the components or steps are formed into integrated circuit components, or several of the components or steps are formed into integrated circuit components. Therefore, the disclosure is not limited to the combination of specific hardware and software.

Although certain example embodiments of the disclosure have been described above, it should be appreciated that the example embodiments are not described for limiting the disclosure and that a variety of modifications and variations can be devised by those of ordinary skill in the art. Any modification, equivalent substitute and improvement that can be devised by those of ordinary skill in the art without departing from the spirit of the disclosure and that the modifications and improvements shall fall within the protection scope of the disclosure.

### INDUSTRIAL APPLICABILITY

As stated above, a method and device for setting a reselection priority, a method and device for determining a reselection category and a method and device for processing a reselection category provided herein have the following beneficial effect: the uniform distribution of idle terminals on multiple carriers is realized.

1. A method for setting a reselection priority, comprising:
receiving a first notification message from a network-side device, wherein the first notification message carries information of multiple carriers or cells supporting stochastic uniform distribution; and
selecting one carrier or cell from the multiple carriers or cells according to the first notification message and setting the reselection priority of the selected carrier or cell.

2. The method as claimed in claim 1, wherein setting the reselection priority of the selected carrier or cell comprises: setting the reselection priority of the selected carrier or cell to be the highest in reselection priorities of the multiple carriers or cells.

3. The method as claimed in claim 2, wherein after setting the reselection priority of the selected carrier or cell, the method further comprises: setting a reselection priority of a currently resident carrier or cell to be lowest in the reselection priorities of the multiple carriers or cells;
or after setting the reselection priority of the selected carrier or cell, the method further comprises: executing a cell reselection operation according to the set reselection priority.

4. (canceled)

5. The method as claimed in claim 43, wherein after executing a cell reselection operation according to the set reselection priority, the method further comprises: setting a timer or acquiring a timer from the network-side device, wherein the set reselection priority is continually used and a reselection priority of a carrier or cell received from a system message is ignored in a time range limited by the timer.

6. The method as claimed in claim 1, wherein after setting the reselection priority of the selected carrier or cell, the method further comprises:
receiving a second notification message from the network-side device, wherein the second notification message is used for notifying to delete the multiple carriers or cells or to set corresponding reselection activation indication fields of multiple carriers or cells to be deactivated; and
deleting or deactivating the multiple carriers or cells according to the second notification message.

7. A method for determining a reselection category, comprising:
determining the reselection category a terminal belongs to; and
notifying the terminal of the reselection category.

8. The method as claimed in claim 7, wherein determining the reselection category the terminal belongs to comprises one of the following steps:
determining the reselection category through a negotiation with the terminal;
allocating the reselection category for the terminal; and
determining the reselection category based on an algorithm supported by the terminal and locally supported;
or reference factors of the reselection category comprise one of: subscription information of the terminal and capability information of the terminal.

9. (canceled)

10. A method for processing a reselection category, comprising:
determining a reselection category list, wherein the reselection category list comprises at least one of: a reselection category of a terminal which keeps residing in a current cell, and a reselection category of a terminal which is to reselect to reside on another carrier; and
notifying a terminal of the reselection category list.

11. The method as claimed in claim 10, wherein while or after notifying the terminal of the reselection category list, the method further comprises:
notifying the terminal of multiple carriers or cells supporting stochastic uniform distribution.

12. The method as claimed in claim 10, wherein the terminal compares a reselection category of the terminal with the received reselection category list to determine that the reselection category of the terminal belongs to a reselection category, which is to reselect onto another carrier, determines a reselection priority of the terminal and perfroms a cell reselection operation according to a list of multiple carriers or cells supporting stochastic uniform distribution received by the terminal.

13. A device for setting reselection priority, comprising:
a first receiving component arranged to receive a first notification message from a network-side device, wherein the first notification message carries information of multiple carriers or cells supporting stochastic uniform distribution; and
a setting component arranged to select one carrier or cell from the multiple carriers or cells according to the first notification message and set the reselection priority of the selected carrier or cell.

14. The device as claimed in claim 13, wherein the setting component is arranged to set the reselection priority of the selected carrier or cell to be the highest in reselection priorities of the multiple carriers or cells.

15. The device as claimed in claim 14, wherein the setting component is also arranged to set a reselection priority of a currently resident carrier or cell to be lowest in the reselection priorities of the multiple carriers or cells;
or further comprising: an execution component arranged to execute a cell reselection operation according to the set reselection priority.

16. (canceled)

17. The device as claimed in claim 4-615, further comprising:
a first processing component arranged to set a timer or acquire a timer from the network-side device, wherein the set reselection priority is continually used and a reselection priority of a carrier or cell received from a system message is ignored in a time range limited by the timer.

18. The device as claimed in claim 13, further comprising:
a second receiving component arranged to receive a second notification message from the network-side device, wherein the second notification message is used for notifying to delete the multiple carriers or cells or to set corresponding reselection activation indication fields of multiple carriers or cells to be deactivated; and
a second processing component arranged to delete or deactivate the multiple carriers or cells according to the second notification message.

19. A device for determining a reselection category, comprising:
a determination component arranged to determine the reselection category a terminal belongs to; and
a notification component arranged to notify the terminal of the reselection category.

20. The device as claimed in claim 19, wherein the determination component is arranged to determine the reselection category a terminal belongs to in one of the following ways:
determine the reselection category through a negotiation with the terminal;
allocate the reselection category for the terminal; and
determine the reselection category based on an algorithm supported by the terminal and the device for determining the reselection category:,
or reference factors of the reselection category comprise one of: subscription information of the terminal and capability information of the terminal.

21. (canceled)

22. A device for processing a reselection category, comprising:
a determination component arranged to determine a reselection category list, wherein the reselection category list comprises at least one of: a reselection category of a terminal which keeps residing in a current cell, and a reselection category of a terminal which is to reselect to reside on another carrier; and
a notification component arranged to notify a terminal of the reselection category list.

23. The device as claimed in clam 22, wherein the notification component is further arranged to notify the terminal of multiple carriers or cells supporting stochastic uniform distribution.
